(19) United States
(12) Patent Application Publication
(10) Pub. No.: US 2012/0163766 A1
(43) Pub. Date: Jun. 28, 2012

(54) REPRODUCTION DEVICE

(75) Inventor: Kenji Morimoto, Hyogo (JP)

(73) Assignee: PANASONIC CORPORATION, Osaka (JP)

(21) Appl. No.: 13/387,779

(22) PCT Filed: Dec. 16, 2010
(86) PCT No.: PCT/JP2010/007297

§ 371 Date: Jan. 30, 2012

(30) Foreign Application Priority Data
Dec. 21, 2009 (JP) 2009-288584

(51) Int. Cl. H04N 5/775; H04N 9/80; H04N 5/93

(52) U.S. Cl. 386/230; 386/353; 386/248; 386/E05.07; 386/E05.028; 386/E09.011

(57) ABSTRACT

A three-dimensional stereoscopic image reproducing apparatus according to the embodiment has a disc reproducing unit 201 capable of reading content recorded in a disc 201, a video decoder 303 for decoding the content read by a disc reproducing unit 201 and outputting at least a video signal, a CPU 305 for generating notifying information for notifying that the content recorded in the disc 201 is 3D content when the content recorded in the disc 201 is 3D content, an output unit 206 for outputting the notifying information or the video signal decoded by the video decoder 305 to an outside of a reproducing apparatus 101. Before the video signal decoded by the decoder 201 is output to the outside of the reproducing apparatus 101, the output unit 206 outputs the notifying information to the outside of the reproducing apparatus 101.

### TECHNICAL FIELD

The present invention relates to a reproducing apparatus for a three-dimensional (3D) stereoscopic image.

### BACKGROUND ART

Conventionally, for a reproducing apparatus for a 3D image, some methods for causing an image for a left eye to be viewed by a human's left eye and an image for a right eye to be viewed by a human's right eye have been realized. For example, a reproducing apparatus reads a video signal for right and left eyes from disc, and outputs the image for right and left eyes alternatively to a display. The display activates alternatively a left-eye shutter and a right-eye shutter of eyeglasses with liquid-crystal shutters to worn by a user, synchronizing with the video signal displayed alternatively. In this configuration, only the image for a left eye is provided to the left eye and only the image for a right eye are provided to the right eye of the user wearing the eyeglasses with the liquid crystal shutters. As a result, the user can view a three-dimensional stereoscopic image.

### PRIOR ART DOCUMENT

### Patent Document

Patent Document 1: JP-2002-82307-A

### OVERVIEW OF INVENTION

### Problem to be Solved by the Invention

When the 3D image reproducing apparatus, can not reproduce a disc which records a conventional two-dimensional (2D) image, an additional reproducing apparatus for reproducing a 2D image is required for reproducing the 2D image, and thus user's convenience is deteriorated. Therefore, a reproducing apparatus which can reproduce both a disc which records a conventional two-dimensional (2D) image and a disc which records a 3D image is demanded. However, when the user uses such a reproducing apparatus that can reproduce both discs, it can be considered that only after an image is displayed on the display apparatus, the user recognizes whether the image recorded in the disc is a 3D image or a 2D image. When the displayed image is a 3D image, the user should prepare to wear the eyeglasses or adjust the 3D image. In this case, if the eyeglasses is prepared after start of reproduction, the reproduction of the 3D image proceeds during the preparation, so that the user occasionally miss a leading part of the video content as the 3D image.

Therefore, it is an object of the present invention to provide a reproducing apparatus which can improve user's convenience when a disc which records a 2D image or a disc which records a 3D image are reproduced.

### Means for Solving Problem

In order to achieve the above object, a reproducing apparatus includes an acquiring unit capable of acquiring a content from an image source, a decoder operable to decode the acquired content and to generate and output at least a video signal, a notifying information generator operable to generate notifying information for notifying that the content recorded in the disc 201 is 3D content when the content from the image source is 3D content, and an output unit operable to output the notifying information or the video signal decoded by the decoder to an outside of the reproducing apparatus. Before outputting the video signal decoded by the decoder to the outside of the reproducing apparatus, the output unit outputs the notifying information to the outside of the reproducing apparatus.

### Effect of the Invention

According to the present invention, before a video signal decoded by the decoder is output outside the reproducing apparatus, notifying information is output outside the reproducing apparatus. Therefore, by displaying the information on a display, for example, a user can be notified that an image recorded in the current disc is a 3D image before reproduction of the video content. For example, a message such as “Please wear 3D eyeglasses.” can be displayed as the notifying information before the reproduction of the video content recorded in the disc. Further, graphics data or text data that can be displayed in a 3D format as the notifying information on the display. This can provide time for preparation and adjustment for the 3D eyeglasses to the user so that the user can prepare and adjust the 3D eyeglasses before the reproduction of the video content. Therefore, the user can view the 3D image more smoothly without missing a part of the video content. According to the present invention, user's convenience can be improved at the time of playing a disc which records a 2D image and a disc which records a 3D image.

### BRIEF DESCRIPTION OF DRAWINGS

FIG. 1 is a configurational diagram illustrating a three-dimensional stereoscopic image reproducing and display system according to a first embodiment.

FIG. 2 is a configurational diagram illustrating a reproducing apparatus according to the first embodiment.

FIG. 3 is a configurational diagram illustrating a signal processor according to the first embodiment.

FIG. 4 is a flowchart illustrating a process of reading ID information according to the first embodiment.

FIG. 5 is a flowchart illustrating a process starting reproduction according to the first embodiment.

FIG. 6A and 6B are diagrams illustrating images to be displayed on a display apparatus in the first embodiment.

FIG. 7 is a diagram illustrating other example of the image to be displayed on the display apparatus in the first embodiment.

### BEST MODE FOR CARRYING OUT THE INVENTION

### First Embodiment

An embodiment will be described.

### 1. Configuration of Three-Dimensional Stereoscopic Image Reproducing and Display System

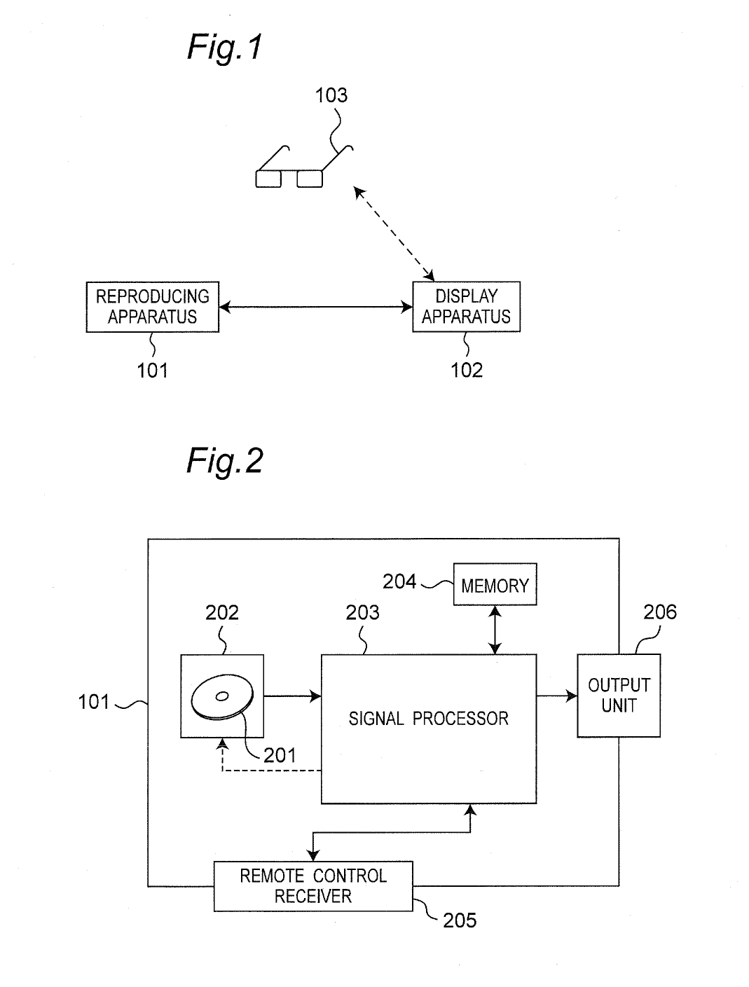

FIG. 1 illustrates a configuration of a three-dimensional stereoscopic image reproducing and display system. The stereoscopic image reproducing and display system includes a reproducing apparatus 101, a display apparatus 102, and 3D eyeglasses 103. The reproducing apparatus 101 reads data of a three-dimensional stereoscopic image (hereinafter, referred to as “3D image”) from a disc to reproduce the image, and output it to the display apparatus 102. The display apparatus 102 displays the 3D image. Concretely, the display apparatus 102 alternatively displays an image for a left eye and an image for a right eye. The 3D eyeglasses 103 have, for example, liquid crystal shutters in a lens part for a left eye and a lens part for a right eye respectively.

The display apparatus 102 transmits a video synchronizing signal to the 3D eyeglasses 103 via wireless, such as infrared rays. The 3D eyeglasses 103 cause the right and left liquid crystal shutters to alternatively open and close, synchronizing with the video synchronizing signal. For example, when the display apparatus 102 displays an image for a left eye, the 3D eyeglasses 103 cause the liquid crystal shutter for a right eye to close, synchronizing with the video synchronizing signal. Further, when the display apparatus 102 displays an image for a right eye, the 3D eyeglasses 103 cause the liquid crystal shutter for a left eye to close, synchronizing with the video synchronizing signal. As a result, the user can view the individual images with the right and left eyes. Since the image for a right eye and the image for a left eye have parallax, the user can view a 3D image based on these images.

### 2. Reproducing Apparatus

FIG. 2 illustrates a configuration of the reproducing apparatus 101. The reproducing apparatus 101 has a disc reproducing unit 202, a signal processor 203, a memory 204, a remote control receiver 205 and an output unit 206. The remote control receiver 205 receives instructions for starting and stopping reproduction from a user. The disc reproducing unit 202 plays a disc 201 which records image data for 2D and 3D, audio data, graphics data, and so on. The disc 201 is an optical disc such as a DVD or a BD. The signal processor 203 decodes the image data, the audio data, the graphics data, and so on, which are reproduced by the disc reproducing unit 202, and temporarily stores them in the memory 204. When the image data, the audio data, the graphics data, or the like, which is stored in the memory 204 is 2D data, the signal processor 203 outputs it in a 2D image format from the output unit 206. When the stored data is 3D data, the signal processor 203 outputs it in a 3D image format from the output unit 206.

### 3. Configuration of Signal Processor

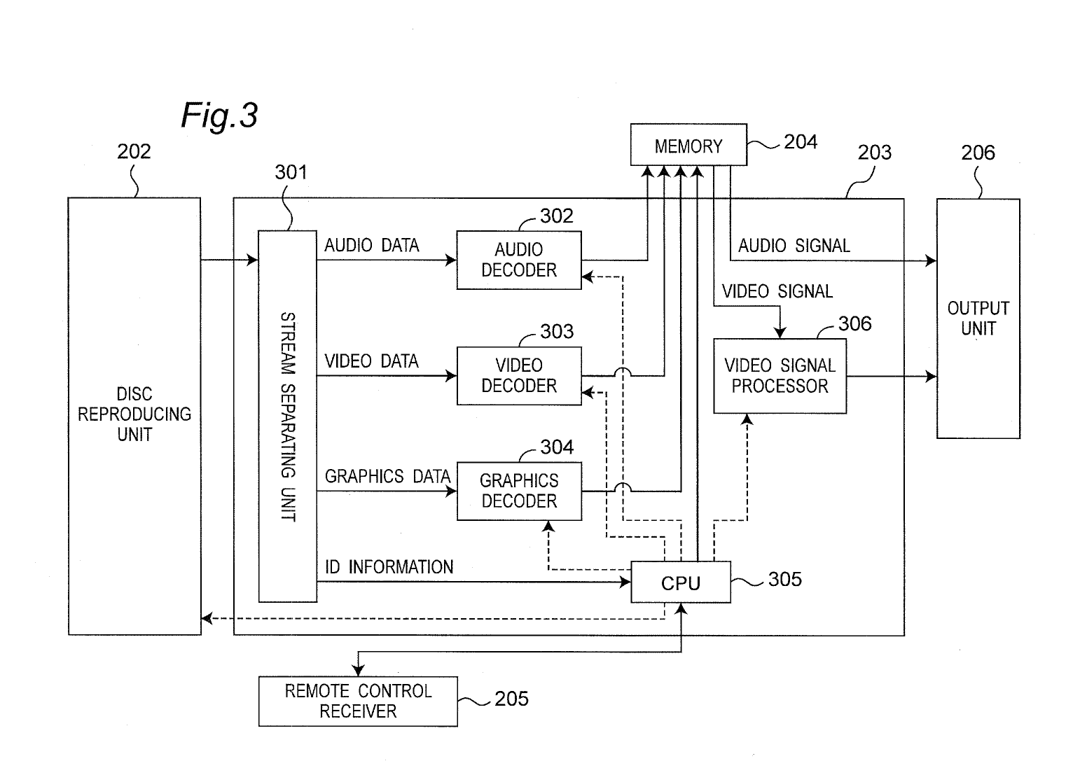

FIG. 3 illustrates a configuration of the signal processor 203. The signal processor 203 has a stream separating unit 301, an audio decoder 302, a video decoder 303, a graphics decoder 304, a CPU 305, and a video signal processor 306. When the CPU 305 receives a signal which represents reception of the user's instruction for starting reproduction from the remote control receiver 205, the CPU 305 outputs an instruction for reproducing the disc 201 to the disc reproducing unit 202. The stream separating unit 301 separates and outputs a content which is read and output from the disc 201 by the disc reproducing unit 202 according to the instruction of the CPU 305, namely, video, audio, graphics (text and menu images) and additional data including ID information. The audio decoder 302 decodes the audio data output from the stream separating unit 301, and transmits it to the memory 204. The video decoder 302 decodes the video data output from the stream separating unit 301, and transmits it to the memory 204. The graphics decoder 304 decodes the graphics data output from the stream separating unit 301, and transmits it to the memory 204. The CPU 305 determines whether a format of the video signal recorded in the disc 201 is a 2D image format or a 3D image format based on the ID information output from the stream separating unit 301. The video signal processor 306 reads the video signal from the memory 204 according to the result of the determination by the CPU 305, and outputs it in the 2D or 3D image format. Further, the CPU 305 determines whether the graphics data is to be combined with the video signal to be output. When the CPU 305 determines that the graphics data is to be combined, the video signal processor 306 combines the graphics data with the video signal and output the signal.

### 4. Operation of the Reproducing Apparatus

4-1. Operation when Disc is Inserted

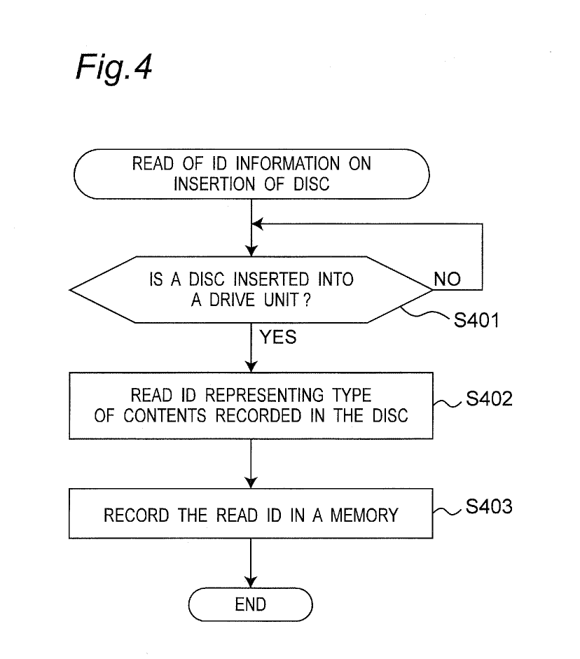

An operation when the disc 201 is inserted into the reproducing apparatus 101 will be described. FIG. 4 is a flowchart illustrating the operation of the reproducing apparatus 101 when the disc is inserted. The CPU 305 detects whether the disc 201 is inserted into the disc reproducing unit 202 (S401). When it is detected that the disc 201 is inserted into the disc reproducing unit 202, the CPU 305 instructs the disc reproducing unit 202 to acquire the ID information recorded in the disc 201. The ID information is information representing whether a 2D image or a 3D image is recorded in the inserted disc 201. With reference to the ID information, it can be understood whether a 2D image or a 3D image are recorded in the inserted disc 201. When receiving the instruction for acquiring the ID information from the CPU 305, the disc reproducing unit 202 reads the ID information from the disc 201, and transmits the ID information to the CPU 305 via the stream separating unit 301 (S402). When the CPU 305 acquires the ID information, it records the acquired ID information in the memory 204 (S403).

### 4-2. Reproducing Operation

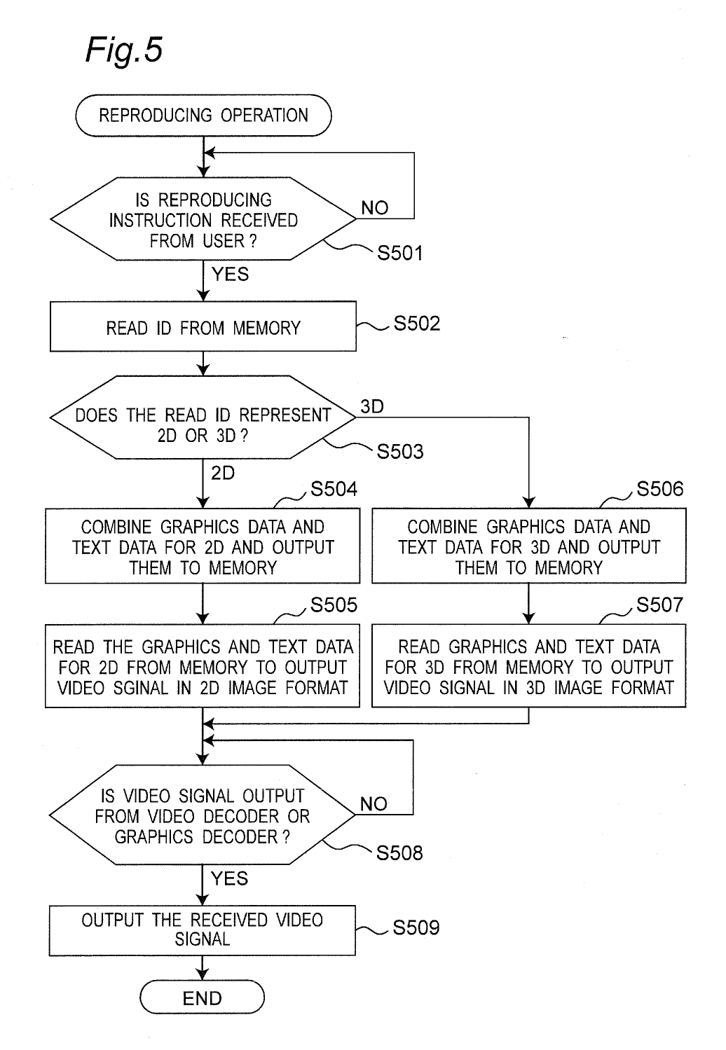

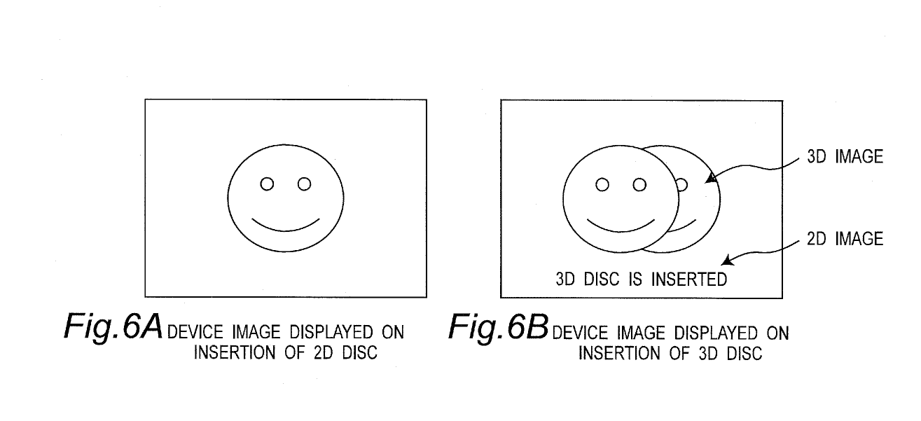

A reproducing operation of the reproducing apparatus 101 will be described. FIG. 5 is a flowchart illustrating the reproducing operation of the reproducing apparatus 101. When the remote control receiver 205 receives an instruction for reproduction from the user (S501), the CPU 305 reads the ID information of the disc 201 recorded in the memory 204 (S502). The ID information is in a format such that the information can be recognized without decoding by a decoder. The CPU 305 determines whether the read ID information represents whether the 2D image or the 3D image is recorded in the inserted disc 201 (S503). When the read ID information represents that a 2D image is recorded in the inserted disc 201, the CPU 305 generates graphics data and text data for 2D image which is recorded in the inserted disc 201a (i.e. graphics data and text data in a 2D image format to notify the user that the image recorded in the inserted disc 201a is a 2D image). The CPU 305 combines the graphics data and the text data, and records the combined data in the memory 204 (S504). The CPU 305 instructs the video signal processor 306 to read the combined data from the memory 204. The video signal processor 306 outputs the read data to an outside via the output unit 206 in the 2D image format for a predetermined time (S505). At this time, the display apparatus 102 displays an image shown in FIG. 6A, for example, based on the graphics data and the text data (FIG. 6A illustrates a case where the text data is not present). The predetermined time may be set, for example, to a time for which a general user can recognize that an image to be reproduced is a 2D image. Either one of the graphics data and the text data may be generated to be output at steps S504 and S505.

On the other hand, when the read ID information represents that the 3D image is recorded in the inserted disc 201, the CPU 305 generates the graphics data and the text data for 3D image which is recorded in the inserted disc 201a is a 3D image (i.e. graphics data and text data in a 3D image format to notify the user that the image recorded in the inserted disc 201a is a 3D image. The CPU 305 combines the graphics data and the text data, and records the combined data in the memory 204 (S506). The CPU 305 instructs the video signal processor 306 to read from the memory 204 the graphics data and the text data combined to be output in the 3D image format. The video signal processor 306 outputs the read data to the outside via the output unit 206 in the 3D image format for a predetermined time (S507). At this time, the display apparatus 102 displays, for example, an image shown in FIG. 6B based on the graphics data and the text data. The predetermined time may be set to a time for which a general user can recognize that an image to be reproduced is the 3D image, wear the 3D eyeglasses 103 to prepare for viewing the 3D image, or check and adjust a viewing state. Either one of the graphics data and the text data may be generated and output at steps S506 and S507.

In the above configuration, before the video decoder 303 decodes a video signal, namely, a video content recorded in the disc 201 is reproduced, the display apparatus 102 displays a message such as “2D disc is inserted.”, “3D disc is inserted.”, “Please wear the 3D eyeglasses 103.”, and “When you view the 3D image for a long time, please take a break.” based on the graphics data. As a result, the user can be notified of whether the image recorded in the disc 201 is a 2D image or a 3D image. Further, by displaying the graphics data and the text data as the 3D image on the display, the user can prepare and adjust the 3D eyeglasses before the reproduction of the video content.

After the 2D or 3D graphics are output, the audio decoder 302, the video decoder 303 and the graphics decoder 304 start to decode the audio data, video data and graphics data of the video content. The CPU 305 determines whether the video signal or a graphic signal of the video content is output from the video decoder 303 or the graphics decoder 304 (S508). When the video signal or the graphic signal of the video content is output from the video decoder 302 or the graphics decoder 304, the CPU 305 changes over the data output from the video signal processor 306 from the data generated based on the ID information to the data output from the video decoder 302 or the graphics decoder 304 (S509). As a result, the reproduction of the video content recorded in the disc 201 is started.

5. Image to be Displayed when Instruction for Reproduction of Disc is Made

FIG. 6 illustrates examples of images to be displayed on the display apparatus 102 when an instruction for reproduction of the disc is made. FIG. 6A illustrates the image to be displayed when a 2D image is recorded in the disc 201 (the image to be displayed at step S505), and FIG. 6B illustrates the image to be displayed when a 3D image is recorded in the disc 201 (the image displayed at step S507). These images are images for notifying the user whether the inserted disc is a disc in which a 2D image is recorded or a disc in which a 3D image is recorded. Hereinafter, they are referred to as “device images” suitably. These device images are generated by the CPU 305 according to the ID information read from the disc before the video content in the disc 201 is reproduced. When the ID information represents that a 2D image is recorded in the disc 201, the CPU 305 generates graphics data of a 2D image format. On the other hand, when the ID information represents that a 3D image is recorded in the disc 201, the CPU 305 generates graphics data of a 3D image format. The text data may be generated and displayed without providing parallax between right and left images so that the text data can be read as 2D image without the eyeglasses even if the text data is in the 3D image format. Since parallax is not provided between the right and left images, even if a 3D image is recorded in the disc 201, the user can read the text data. Therefore, the user can be prompted to prepare the 3D eyeglasses 103. Further, a part of the text data may be output in the 3D image format as a 3D image, so that the user wearing the 3D eyeglasses 103 can prepare for viewing of a 3D image, or can check and adjust the viewing state.

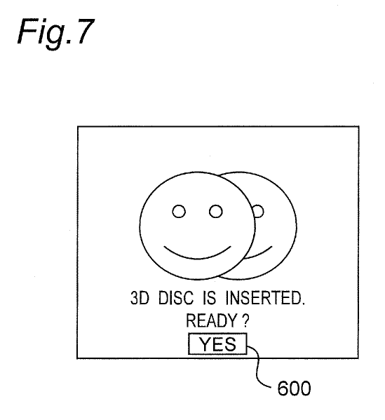

When the instruction of the reproduction of the disc 201 in which the 3D image is recorded is made, an image shown in FIG. 7 may be displayed. That is to say, in addition to the image shown in FIG. 6B, a message “Is preparation done?” is further displayed, and an operation button for acknowledgment (“YES” button) 600 may be displayed. This device image is continuously displayed until the user operates the operation button 600. That is to say, the start of display of the video content is held. As a result, the user can securely view the leading part of the video content. When predetermined time elapses after the display of the image shown in FIG. 7, the display of the video content may be started. The predetermined time may be set to time, for example, for which a general user can recognize that an image to be reproduced is a 3D image, prepare for viewing of 3D image by wearing the 3D eyeglasses 103, and check and adjust the viewing state.

### 6. Summary

The reproducing apparatus 101 according to this embodiment has the disc reproducing unit 202 that can read content recorded in the disc 201, the video decoder 302 that decodes the content read by the disc reproducing unit 202 and outputs at least a video signal, the CPU 305 generates notifying information for notifying that the content recorded in the disc 201 is 3D content when the content recorded in the disc 201 is 3D content, the output unit 206 that outputs the notifying information or the video signal decoded by the video decoder 302 to the outside of the reproducing apparatus 101. Before outputting the video signal decoded by the video decoder 302 to the outside of the reproducing apparatus 101, the output unit 206 outputs the notifying information to the outside of the reproducing apparatus 101.

With this configuration, before the video decoder 302 decodes the video signal, namely, the video recorded in the disc 201 is reproduced, the display apparatus 102 displays the messages such as “2D disc is inserted.”, “3D disc is inserted.”, “Please wear the 3D eyeglasses 103.”, and “When the 3D image is viewed for a long time, please take a break”. As a result, the user can be notified whether the image recorded in the disc 201 is a 2D image or a 3D image. Further, the graphics data and the text data can be displayed as a 3D image on the display. With this arrangement, the time for preparing for and adjusting the 3D eyeglasses 103 can be provided to the user, so that the user can prepare for and adjust the 3D eyeglasses 103 before reproduction of the video content in the disc. Therefore, the user can view the 3D image more smoothly without missing a part of the video content. According to the present invention, user's convenience for reproduction of a disc in which a 2D image is recorded or a disc in which a 3D image is recorded can be improved.

In addition, in the reproducing apparatus 101 according to this embodiment, when the ID information representing whether the recorded content is 2D content or 3D content is recorded in the disc 201, the disc reproducing unit 202 can read the ID information. Further, the reproducing apparatus 101 has the memory 204 for storing the ID information read by the disc reproducing unit 202. The CPU 305 generates the notifying information for notifying that the content recorded in the disc 201 is 2D content or 3D content based on the ID information recorded in the memory 204.

With the above arrangement, the notifying information can be suitably generated based on the ID information representing whether the 2D content or the 3D content is recorded in the disc 201.

Further, the reproducing apparatus 101 according to this embodiment has the remote control receiver 205 for receiving the instruction for reproducing the content recorded in the disc 201 from the user. When the remote control receiver 205 receives the instruction for reproducing the content recorded in the disc 201 from the user, the output unit 206 outputs the notifying information. On the other hand, the disc reproducing unit 202 starts to read the content recorded in the disc 201. After the content read by the disc reproducing unit 202 is decoded by the video decoder 302, the output unit 206 changes over the output from the notifying information to the video signal decoded by the video decoder 302.

With this arrangement, after the user instructs the reproduction, the user can determine whether the content to be reproduced is a 3D image or a 2D image based on the notifying information even before the reproduction of the content.

Further, in the reproducing apparatus 101 according to this embodiment, when the disc 201 is inserted into the reproducing apparatus 101, the disc reproducing unit 202 reads an ID information and records it in the memory 204.

With this arrangement, when the instruction for reproducing is received, the ID information does not have to be read from the disc 201. Therefore, the notifying information can be presented to the user more quickly.

The notifying information in this embodiment may be a message representing that the content to be reproduced is 3D content, or may be a 3D image.

### Other Embodiments

The first embodiment has been illustrated as the embodiment of the present invention. However, the present invention is not limited to this. Other embodiments of the present invention will be described below. The present invention is not limited to these embodiments, and can be applied also to suitably modified embodiments.

In the reproducing apparatus 101 according to the first embodiment, the display apparatus 102 displays the device images shown in FIGS. 6 and FIG. 7 regardless of whether the display apparatus 102 can reproduce a 3D image. However, the device image to be displayed on the display apparatus 102 may be changed according to whether the display apparatus 102 can reproduce a 3D image. For example, the reproducing apparatus 101 is provided with an HDMI interface, and an inquiry is made at the display apparatus 102 about whether a 3D image can be displayed via HDMI interface. When a response such that the display is possible is made, the reproducing apparatus 101 outputs the images shown in FIGS. 6 and FIG. 7. On the other hand, when the response such that the 3D image can be displayed is not made or a response such that the 3D image cannot be displayed is made, the display apparatus 102 currently connected is deemed as an apparatus that can display only a 2D image, and a message “The 3D image cannot be displayed” is displayed.

In the first embodiment, the display apparatus 102 selects and displays an image for a left eye and an image for a right eye alternatively, and the right and left lens shutters in the 3D eyeglasses 103 are opened and closed in synchronization with the selection so that the user can view the right and left images alternatively. However, the present invention is not limited to such a configuration. For example, the display apparatus 102 displays the image for a left eye and the image for a right eye separately on odd-numbered lines and even-numbered lines, with different deflection films stuck to the odd-numbered lines and the even-numbered lines. The 3D eyeglasses 103 do not have a crystal shutter but may be configured so that deflection filters of different directions are stuck to the right and left lenses to separate the images for right and left eyes. Further, the display apparatus may alternatively display images for right and left eyes by one pixel in a horizontal direction, with deflection films having different deflection planes stuck alternatively by one pixel. In other words, the present invention is not limited to the particular 3D system and can be applied to any systems as long as image data for left eye and image data for right eyes reaches, as the 3D image, the user's left and right eyes, respectively.

In the first embodiment, the reproducing apparatus 101 is configured so as to reproduce the data in the disc 201 (for example, Blu-ray disc, DVD disc) output from the disc reproducing unit 202. But an image source is not limited to discs. The idea of the first embodiment can be applied also to a case of reproduction from various image sources such as stream input from a broadcasting station or via a network, and reproduction from recording medium such as a memory card and a USB memory.

Further, when the disc 201 is inserted, the disc reproducing unit 202 acquires the ID information and records it in the memory 204. But when an instruction for starting reproduction is received from the user, the disc reproducing unit 202 may acquire the ID information from the disc 201 and records it in the memory 204.

Further, when the remote control receiver 205 receives the instruction for reproducing the content recorded in the disc 201 from the user, the disc reproducing unit 202 may read the ID information recorded in the disc 201 and records it in the memory 204.

After the reproduction is instructed from the user, the reproduction of the content in the disc 201 is started, but a device image is displayed and the content in the disc 201 may be automatically reproduced only by inserting the disc 201.

After the reproduction is instructed from the user, the device image is displayed, but the device image may be displayed only by inserting the disc 201. With such a configuration, when the disc 201 is inserted into the reproducing apparatus 101, the output unit 206 outputs the notifying information. The disc reproducing unit 202 starts to read the content recorded in the disc 201. After the video decoder 303 decodes the content read by the disc reproducing unit 202, the output unit 206 changes over the output from the notifying information to the video signal decoded by the video decoder 303.

Further, before the reproduction of the disc 201 is started, the device image is displayed, but when the reproduction from the disc 201 is stopped, the device image may be again displayed.

Further, when the disc 201 is a disc in which a 3D image is recorded, a 3D device image is displayed. However, head image data of the video content in the disc or the graphics data (a menu and so on) may be displayed, and a pause image may be displayed, and the device image may be combined with a content image to be displayed. With this arrangement, the user can be notified that the 3D disc is inserted. Further, the user can be prompted to wear the 3D eyeglasses 103.

### INDUSTRIAL APPLICABILITY

The present invention relates to a reproducing apparatus that can reproduce a 3D image. Particularly, the present invention causes the apparatus that supports both the 2D/3D discs to display a device image before the video content is reproduced with the disc recording contents inserted in the apparatus, so that the user can be notified of the particular display of a 3D image. Thus, the user can be prompted to wear the 3D eyeglasses. Further, the user can prepare for and adjust the 3D eyeglasses.

The present invention can be applied to devices compatible with three-dimensional stereoscopic images, such as a 3D Blu-ray disc player, a 3D Blu-ray disc recorder, a 3D DVD player, a 3D DVD recorder, a 3D broadcast receiver, a 3D television, a 3D image display terminal, a 3D mobile telephone terminal, a 3D car navigation system, a 3D digital still camera, a 3D digital movie camera, a 3D network player, a 3D-compatible computer, and a 3D-compatible game player.

### EXPLANATIONS OF LETTERS OR NUMERALS

101 reproducing apparatus
102 display apparatus
103 3D eyeglasses
201 disc
202 disc reproducing unit
203 signal processor
204 memory
205 remote control receiver
206 output unit
301 stream separating unit
302 audio decoder
303 video decoder
304 graphics decoder
305 CPU
306 video signal processor

1. A reproducing apparatus, comprising:
an acquiring unit operable to acquire a content from an image source;
a decoder operable to decode the acquired content and to generate and output at least a video signal;
a notifying information generator operable to generate notifying information for notifying that the content acquired from the image source is 3D content when the content acquired from the image source is 3D content; and
an output unit operable to output the notifying information or the video signal decoded by the decoder to an outside of the reproducing apparatus,
wherein before the video signal decoded by the decoder is output to the outside of the reproducing apparatus, the output unit outputs the notifying information to the outside of the reproducing apparatus, and
the notifying information includes graphics data composed of a 3D image and text data composed of a 2D image.

2. The reproducing apparatus according to claim 1, wherein
the acquiring unit acquires, from the image source, ID information representing whether the content acquired from the image source is 2D content or 3D content,
the notifying information generator generates the notifying information for notifying whether the content recorded in the image source is 2D content or 3D content based on the acquired ID information.

3. The reproducing apparatus according to claim 1, further comprising:
a receiving unit operable to receive an instruction from a user for reproducing the content acquired from the image source, wherein
when the receiving unit receives the instruction for reproducing, the output unit outputs the notifying information, and the acquiring unit starts to acquire the content from the image source,
the decoder starts to decode the content acquired by the acquiring unit after the output unit outputs the notifying information, and
thereafter, the output unit changes over the output from the notifying information to the video signal decoded by the decoder.

4. The reproducing apparatus according to claim 2, further comprising:
a receiving unit operable to receive an instruction from a user for reproducing the content acquired from the image source,
wherein the acquiring unit acquires the ID information from the image source when the receiving unit receives the instruction from the user for reproducing the content acquired from the image source.

5. The reproducing apparatus according to claim 2, wherein
the image source is a disc, and
the acquiring unit acquires the ID information recorded in the disc when the disc is inserted into the reproducing apparatus.

6. The reproducing apparatus according to claim 1, wherein
the image source is a disc,
when the disc is inserted into the reproducing apparatus, the output unit outputs the notifying information, and the acquiring unit starts to acquire the content recorded in the disc,
the decoder starts to decode the content acquired by the acquiring unit after the output unit outputs the notifying information, and
thereafter, the output unit changes over the output from the notifying information to the video signal decoded by the decoder.

7. The reproducing apparatus according to claim 1, wherein the image source is a disc.

8. (canceled)

9. (canceled)

10. (canceled)

11. The reproducing apparatus according to claim 1, further comprising:
a detecting unit operable to detect whether a display apparatus to which the reproducing apparatus outputs the video signal can display a 3D image,
wherein the notifying information generator changes content of the notifying information according to a detected result of the detecting unit.

12. The reproducing apparatus according to claim 3, wherein
the notifying information includes selection information for requesting a selection from a user as to whether the content is to be reproduced,
the receiving unit can receive the selection on the selection information by the user,
the output unit continues to output the notifying information, after the receiving unit receives the instruction for reproduction, until the receiving unit receives the user's selection that the content is to be reproduced, and
after the receiving unit receives the user's selection that the content is to be reproduced, the output unit outputs the content.

13. The reproducing apparatus according to claim 6, wherein
the notifying information includes selection information for requesting a selection from a user as to whether the content is to be reproduced,
the receiving unit can receive the selection on the selection information by the user,
the output unit continues to output the notifying information, after the disc is inserted in the reproduction apparatus and the output unit outputs the notifying information, until the receiving unit receives the user's selection that the content is to be reproduced, and
after the receiving unit receives the user's selection that the content is to be reproduced, the output unit outputs the content.

14. A reproducing apparatus for reproducing 2D content or 3D content from a disc inserted therein, the reproducing apparatus comprising:
an disc reproducing unit operable to acquire ID information and the 2D content or the 3D content from the disc inserted into the reproducing apparatus, the ID information representing whether the 2D content or 3D content is recorded on the disc;
a decoder operable to decode the 2D content or 3D content acquired by the disc reproduction unit and output a 2D signal or 3D signal, respectively;
a notifying information generator operable to generate notifying information for notifying whether the 2D content or 3D content is recorded on the disc based on the ID information acquired by the disc reproducing unit; and
an output unit operable to output the notifying information to an outside of the reproduction apparatus before outputting the 2D signal or 3D signal to the outside of the reproducing apparatus.

15. The reproducing apparatus according to claim 14, wherein the notifying information is either graphics data and text data in a 2D format to notify that the 2D content is recorded on the inserted disc, or graphics data and text data in a 3D format to notify that the 3D content is recorded on the inserted disc.

16. The reproducing apparatus according to claim 14, wherein the output unit outputs the 2D signal or 3D signal to the outside of the reproducing apparatus after a predetermined time has elapsed since the notifying information has been outputted to the outside of the reproduction apparatus.

17. The reproducing apparatus according to claim 14, further comprising:
a receiving unit operable to receive an acknowledgment from a user;
wherein the output unit outputs the 2D signal or 3D signal to the outside of the reproducing apparatus after the notifying information has been outputted to the outside of the reproduction apparatus and after the user acknowledgement has been received by the receiving unit.
